(19) United States
(12) Patent Application Publication
(10) Pub. No.: US 2005/0063130 A1
(43) Pub. Date: Mar. 24, 2005

(54) Electrical ionizer

(76) Inventors: Christopher Francis, Marston Meysey (GB); Simon Hatcher, Carterton (GB); David Rogers, Duddugtan (GB); David Stephen, Exmouth (GB)

Correspondence Address: INTELLECTUAL PROPERTY / TECHNOLOGY LAW, PO BOX 14329, RESEARCH TRIANGLE PARK, NC, 27709, US

(21) Appl. No.: 10/943,764

(22) Filed: Sep. 17, 2004

(30) Foreign Application Priority Data
Sep. 22, 2003 (GB) 0322160.3

(51) Int. Cl. H02H 1/04

(52) U.S. Cl. 361/220

(57) ABSTRACT

An electrical ionizer comprising a fan (5) for producing a laminar flow of air; a positive ion emitter (6b) for ejecting positive ions into the flow of air; a negative ion emitter (6a) for ejecting negative ions into the flow of air; a positive voltage supply (27) to the positive ion emitter; a negative voltage supply (28) to the negative ion emitter; and a microprocessor (30) for controlling the positive and negative voltages to obtain a desired ion balance in the flow of air. The fan (5) is a crossflow fan, resulting in a highly uniform and laminar beam of air along the entire length of the fan, with reduced gaps in the air flow and consistent velocity of air, improving ion balance. The use of a crossflow fan also enables the operating mechanism to be contained within a simple “teardrop” profile, and for operative parts of the device, for example the motor, the bearings, and electronics such as printed circuit boards to be housed outside the air flow, thereby eliminating a possible source of contamination of the air flow. For a comparable size of ionizer enclosure, approximately twice the mass flow, at higher velocities, can be generated as a similar conventional device using axial fans, and at reduced noise levels.

### FIELD OF THE INVENTION

The present invention relates to electrical ionizers, in particular electrical ionizers for use in “clean rooms” used for the assembly of sensitive electronic equipment, such as semiconductor devices, computer components, hard disks, LCDs, etc.

### BACKGROUND OF THE INVENTION

Electrical ionizers are commonly used in such environments to generate ions in the air and thereby enable neutralization of surface charges. In the majority of applications, the reduction of a static charge to a few hundred volts is nominally sufficient to eliminate dust attraction. In the electronics industry, however, and in particular, in clean rooms, static charges of a few hundred volts can have disastrous effects on semiconductor devices such as micro-processor chips. In these instances it is important to ensure that the ionization delivered by a neutralization system is balanced and targeted specifically to areas where neutralization is required. In many applications, build-up of static charge must be limited to a few volts, possibly as low as +/−1V or less.

Electrical ionizers used in such applications generally have one or more fans for directing a flow of ionized air and targeting it at a workbench at a distance from the electrical ionizer. Many electrical ionizers of this kind constantly monitor the ion output to ensure that the flow of air leaving the ionizer is balanced to enable very exact neutralization.

The practice in the industry is to employ one or more axial fans (i.e., one in which the airflow is axial with the rotation axis of the fan) to drive an airflow over or past an ionizing source (emitters) and then downward onto the surface to be neutralized. Axial fans have a number of problems. The air flow that they produce is turbulent. This can lead to ion recombination which can in turn upset the ionization balance, and is more likely to lead to contamination. In addition, since many applications require the ionizing flow along an elongate work surface, it is often necessary to use installations comprising multiple axial fans in a side-by-side arrangement. Air flow velocities can vary from fan to fan when a series of axial fans is used, and gaps or areas of overlap can arise in the airflow, caused by the spacing between fans and the pattern of the airflow from the fans. This makes the control of the ionization balance very difficult to achieve. Attempts have been made to overcome the problem of ion imbalance by using a dedicated control circuit for each of the fans. This has some beneficial effect on ion balance but separate control circuits create problems in achieving a balanced overall set-up, and result in additional expense.

In order to obtain a suitable flow at the work surface while leaving sufficient space above the work surface for a worker to operate, it is necessary to run the axial fans at relatively high speed. This can be very noisy, especially where there are a large number of fan installations in a room.

Finally, the very nature of an axial fan means that at least part of the drive mechanism must be located in the air flow. In most cases, the motor is mounted in the centre of the fan. This can quickly lead to unacceptable levels of particulate contamination.

Fans incorporating ionizers are known in a number of different applications. U.S. Pat. No. 4,757,422, U.S. Pat. No. 4,878,149, GB 1 356 211 and EP 1 067 828 all describe different approaches to providing ionized air flows for industrial applications. U.S. Pat. No. 4,794,486, WO 02/17978 and EP 1 293 216 describe ionizing apparatus for use in air conditioning. GB 2 023 351 describes the use of an ionizer in a hair dryer.

### SUMMARY OF THE INVENTION

According to a first aspect of the present invention, there is provided an electrical ionizer comprising:
a crossflow fan for producing a laminar flow of air;
a positive ion emitter for ejecting positive ions into the flow of air;
a negative ion emitter for ejecting negative ions into the flow of air;
means for supplying a positive voltage to the positive ion emitter;
means for supplying a negative voltage to the negative ion emitter; and
control means for controlling the said positive and negative voltages to obtain a desired ion balance in the flow of air.

A crossflow fan, in the sense in which that term is used herein, is a fan in which the airflow exiting the fan is generally perpendicular to the rotation axis of the fan. Crossflow fans typically consist of a plurality of generally parallel vanes arranged in a cylindrical configuration about a rotation axis, and confined within a fan enclosure with an elongate air inlet and an elongate air outlet disposed generally parallel to the rotation axis, at different radial positions around the rotation axis. Air is entrained by the vanes at the inlet, and centrifugally expelled at the outlet.

The flow of air thus produced is generally a highly uniform and laminar beam of air along the entire length of the fan. The use of such a fan in an ionizer is therefore highly advantageous in preventing gaps in the air flow and maintaining a consistent velocity of air to ensure good ion balance.

The use of a crossflow fan not only permits an improvement in the air flow, it also enables the operating mechanism to be contained within a simple “teardrop” profile. It also makes it possible for most of the operative parts of the device, for example the motor, the bearings, and electronics such as printed circuit boards to be housed outside the air flow, thereby eliminating a possible source of contamination of the air flow. It is also found that, for a comparable size of ionizer enclosure, it is possible to generate approximately twice the mass flow, at higher velocities, as a similar conventional device using axial fans. Much quicker charge neutralization and more even offset voltages across the target surface can therefore be achieved. Noise levels are also considerably reduced.

The positive and negative ion emitters can comprise multiple emitting elements such as pin electrodes or the like.

The electrical ionizer preferably includes means for setting a reference value representative of the desired ionic balance in the flow of air, for example a manually-adjustable potentiometer. An ionic balance sensor may also be provided, for measuring the actual ionic balance in the flow of air, and the control means may include means for comparing the reference value with the value measured by the ionic balance sensor, to generate a control voltage for controlling said positive and negative voltage supply to the ion emitters. The control means can also include indicators and alarms for displaying the status of the ionizer and drawing attention when faults or possible problems occur. For example, alarms or indicators can be provided for indicating dirty emitter pins on detection of low current readings.

Connection means, for example an electrical connector, may also be provided, for connecting a remote sensor for measuring the ionic balance in the flow or air at a distance remote from the ionizer. The use of a remote sensor can be of particular value if, for example, the calibration of the unit changes, because of a change in the distance between an ionizer and its target work surface, or because of a change in the humidity or temperature of the surroundings.

In a preferred embodiment the ionizer includes means for generating an alarm signal when the ion balance in the ionized air drifts by more than a desired amount from the reference value, for example by more than +/−25V. When the reference value is set manually by means of a potentiometer, means are preferably provided for detecting the potentiometer setting, in order that the “out of balance” trigger levels may be set appropriately. In a particularly convenient embodiment, this may be done by providing an optical sensor for sensing a change in the potentiometer setting, and for resting the trigger levels around the new calibration point, when the optical sensor detects that the calibration point has changed. The ionizer may also be arranged to automatically shut down in cases of detection of serious faults.

The invention also extends to a method of producing a flow of air containing positive and negative ions, comprising operating an ionizer as described above.

### BRIEF DESCRIPTION OF THE DRAWINGS

A preferred embodiment of the invention will now be described, with reference to the accompanying drawings, in which:

FIG. 1 shows a schematic front-view of an electrical ionizer in accordance with the invention,

FIG. 2 is a section on AA of FIG. 1, and

FIG. 3 is a simplified schematic diagram of the control circuitry associated with the device of FIG. 1.

### DETAILED DESCRIPTION OF THE PREFERRED EMBODIMENT

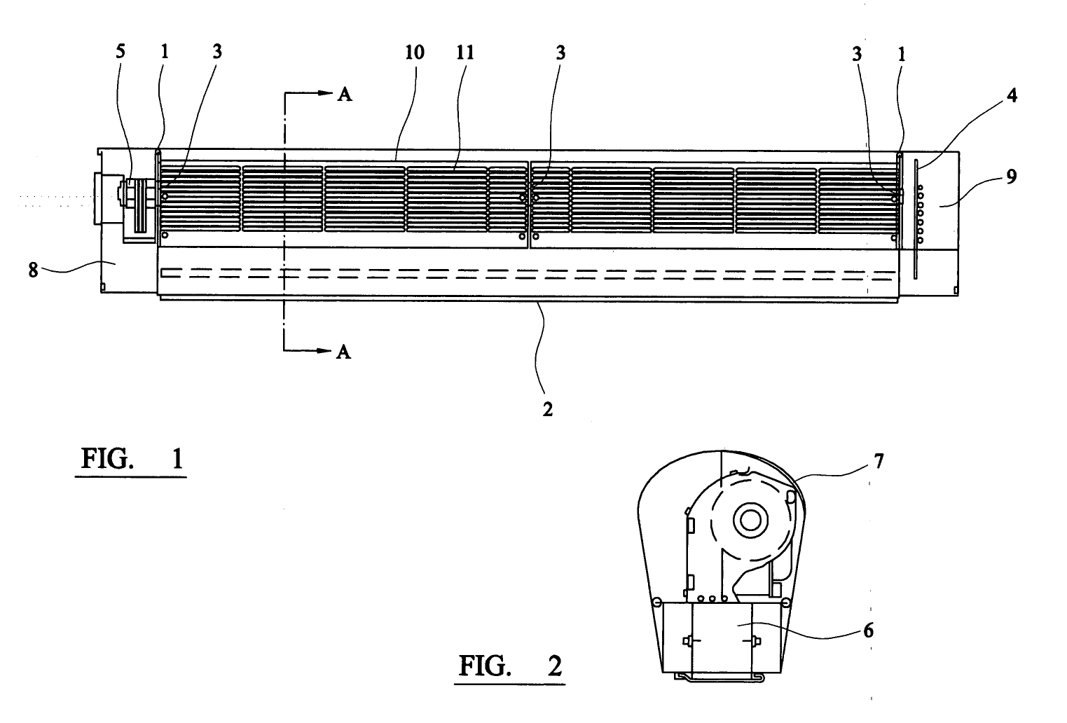

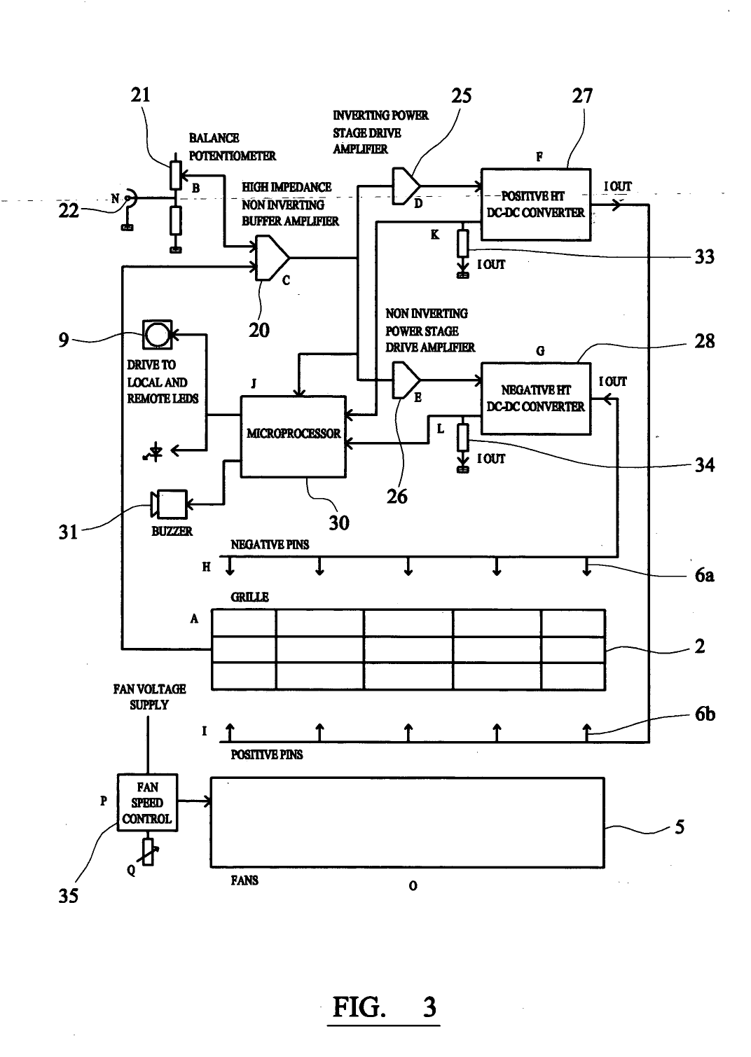

FIGS. 1 and 2 show an electrical ionizer according to one embodiment of the invention that is suitable for use in a clean room environment. The ionizer comprises a crossflow fan having an impeller 10, driven by an impeller motor 5, and housed within a casing 7. The casing is fabricated from stainless steel (other materials suitable for use in a clean room environment can also be used) and has a “teardrop” profile as is evident from FIG. 2. This profile allows the ionizer to be positioned in the laminar downdraft air flow encountered in clean rooms without unduly disturbing this airflow.

Air enters the unit through an inlet 11, and is expelled through an exit opening 12. Bulkheads 1 are provided at each end of the unit and are sealed to the outer casing 7 by means of gaskets, so as to confine the air flow within the desired part of the unit. The Bulkheads 1 also prevent particulate contamination originating with the motor 5 and associated control electronics form entering the air flow.

Control circuitry is provided on a printed circuit board 4, at the end of the unit opposite the impeller motor 5. Sealed bearings 3 are used to prevent ingress of dust into the air flow. Emitter pin 6a and 6b located in the airflow exit 12 are connected respectively to negative and positive high voltage sources 28 and 27 in FIG. 3. A sensor grille 2 is provided at the outlet of the unit, for measuring the ion balance in the air leaving the unit.

As shown in FIG. 3, sensor grille 2 provides one of two inputs to a high impedance non-inverting buffer amplifier 20. The other input to amplifier 20 is provided by a balance potentiometer 21. A connection point 22 is provided for connection of a remote sensor (not shown) which may be located for example on the work bench. Output from amplifier 20 is passed to the input of respective inverting power stage drive amplifiers 25 and 26. Amplifiers 25 and 26 respectively provide drive inputs for a positive high tension DC-DC converter 27, and a negative high tension DC-DC converter 28. Outputs from DC converters 27 and 28 are connected respectively to positive and negative emitter pin arrays 6b and 6a. The DC-DC converters 27 and 28 are fixed duty cycle resonant converters, with an HT output which is proportionate to the applied DC input.

The resulting output current from each is sensed in ground referenced resistors 33 and 34 respectively, and the resulting voltages passed to microprocessor 30. Microprocessor 30 is programmed and arranged to monitor reduction in ion current with time, and to generate an alarm and/or shut down the unit, via status indicator LEDs 9, and buzzer 31 if the values exceed pre-defined limits.

An additional input to microprocessor 30 is provided by an optical sensor (not shown) arranged to sense change in the setting of potentiometer 21.

The fan speed may be controlled by a fan speed selector switch 35 (an alternative is a potentiometer or a slide switch/tapped motor winding).

In the event that the relative voltage to the negative and positive pin erase 6a and 6b cannot be adjusted to the desired level, and “out of balance” indicator in LED's 9 is illuminated. The level of voltage that typically triggers the “out of balance” alarm is typically set at +/−25V, although for some applications it may be set asymmetrically. However, the trigger voltage may be adjusted within a range of, for example, +/−5V to +/−75V, depending upon the specific application requirements. The limits of the range may be selected according to requirements.

The microprocessor is preferably programmed and arranged so as to turn off the high voltage supplies to the emitter arrays, in the event of an excessive “out of balance” signal, in order to minimize the likelihood of damage to sensitive components being processed. Detection of the positive and negative ion currents, via the voltages produced at resistors 33 and 34 can also be used by the microprocessor to ascertain whether the emitter pin 6a and 6b have become dirty or degraded. When the currents fall to below a pre-set level (for example 40% of their initially calibrated levels) an alarm is indicated on the LED's 9. A buzzer or other audible alarm can sound to indicate the fault.

A remote sensor may be connected to the external connector 22. The signal from the remote sensor is fed into the circuit and merged with the grille control signal to control the ion balance of the unit. The merging of these two signals is found to improve both short and long term ion balance stability. In normal operation, ion balance can typically be maintained to within +/−2V. The use of a remote sensor enables us to improve to +/−0.5V.

A remote connector may also be provided to printed circuit board 4, to enable various functions to be monitored, for example when inspection of the emitter arrays is required, when shut down has been activated, when power to the unit has been switched on, when positive and/or negative out of balance conditions have occurred, and the current value of the sensor or signal.

It will be clear to one of skill in the art that numerous variations are possible with the scope of the appended claims in addition to the embodiment specifically described above.

1. An electrical ionizer comprising:
a crossflow fan for producing a laminar flow of air;
a positive ion emitter for ejecting positive ions into the flow of air;
a negative ion emitter for ejecting negative ions into the flow of air;
a positive voltage supply connected to the positive ion emitter;
a negative voltage supply connected to the negative ion emitter; and
a controller for adjusting and controlling the positive and negative voltages in use to obtain a desired ion balance in the flow of air.

2. An electrical ionizer as claimed in claim 1, wherein the positive and negative voltage supplies are steady state DC supplies.

3. An electrical ionizer as claimed in claim 1, wherein the crossflow fan is located in a casing having a teardrop-shaped cross section.

4. An electrical ionizer as claimed in claim 3, wherein the housing is made from stainless steel.

5. An electrical ionizer as claimed in claim 1, further comprising means for setting a reference value representative of the desired ionic balance in the flow of air, an ionic balance sensor for measuring the actual ionic balance in the flow of air, wherein the controller compares the reference value with the value measured by the ionic balance sensor, to generate a control voltage for adjusting the positive and negative voltage supply to the ion emitters in order to achieve the desired ion balance.

6. An electrical ionizer as claimed in claim 5, wherein the means for setting a reference value includes a potentiometer.

7. An electrical ionizer as claimed in claim 6, further comprising a sensor for sensing variations in the potentiometer setting.

8. An electrical ionizer as claimed in claim 7, wherein the sensor includes an optical sensor.

9. An electrical ionizer as claimed in claim 1, further comprising a connector for connecting a remote sensor for measuring the ionic balance in the flow of air at a distance remote from the ionizer.

10. An electrical ionizer as claimed in claim 9, including means for merging a signal from the remote sensor with the signal from the ion balance sensor.

11. An electrical ionizer as claimed in claim 1, further comprising a microprocessor.

12. An electrical ionizer as claimed in claim 1, further comprising a display for indicating out of balance conditions.

13. An electrical ionizer as claimed in claim 1, further comprising a fan controller located outside the flow of air.

14. A method of producing a flow of air containing positive and negative ions, comprising operating an ionizer comprising:
a crossflow fan for producing a laminar flow of air;
a positive ion emitter for ejecting positive ions into the flow of air;
a negative ion emitter for ejecting negative ions into the flow of air;
a positive voltage supply connected to the positive ion emitter;
a negative voltage supply connected to the negative ion emitter; and
a controller for adjusting and controlling the positive and negative voltages in use to obtain a desired ion balance in the flow of air.

15. A method as claimed in claim 13, further comprising the steps of:
setting a reference value representative of the desired ionic balance in the flow of air;
measuring the actual ionic balance in the flow of air;
comparing the measured ionic balance with the reference value; and
generating a control voltage for adjusting the positive and negative voltage supplies to the ion emitters in order to achieve the desired ion balance.

16. A method as claimed in claim 14, further comprising sensing the ionic balance in the flow of air at a distance remote from the electrical ionizer, by means of a remote sensor.

17. A method as claimed in claim 16 further comprising calibrating the ionic balance sensor from the remote sensor.

18. A method as claimed in claim 14, comprising supplying steady state DC from the positive and negative voltage supplies.
